(19) United States
(12) Patent Application Publication
(10) Pub. No.: US 2021/0158253 A1
(43) Pub. Date: May 27, 2021

(54) SYSTEM FOR EXECUTING AUTOMATIC RESOURCE TRANSFERS USING PREDICTIVE ELECTRONIC DATA ANALYSIS

(71) Applicant: Bank of America Corporation, Charlotte, NC (US)

(72) Inventors: Heather Roseann Dolan, Sarasota, FL (US); Christina Lillie, Ann Arbor, MI (US); Justin Riley duPont, Charlotte, NC (US); Malathi Jivan, San Jose, CA (US); Poppy Marie Kimball, Redwood City, CA (US)

(73) Assignee: Bank of America Corporation, Charlotte, NC (US)

(21) Appl. No.: 16/690,966

(22) Filed: Nov. 21, 2019

(51) Int. Cl. G06Q 10/06; G06N 5/02

(52) U.S. Cl. CPC G06Q 10/06315; G06N 5/02

(57) ABSTRACT

A system provides a way to execute automatic and/or recurring resource transfers using predictive electronic data analysis. In particular, the system may continuously collect resource transfer data associated with a user. Based on the collected resource transfer data, the system may extract resource transfer patterns and subsequently generate a prediction of a resource transfer to occur in the future. In this regard, the system may use a scoring algorithm to calculate the degree of correlations between certain resource transfers. The system may then transmit one or more recommendations regarding the predicted resource transfer to the user. In this way, the system may provide an efficient way to execute resource transfers.

### FIELD OF THE INVENTION

The present disclosure embraces a system for executing automatic resource transfers using predictive electronic data analysis.

### BACKGROUND

There is a need for a more effective way to execute and coordinate resource transfers.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for executing automatic and/or recurring resource transfers using predictive electronic data analysis. In particular, the system may continuously collect resource transfer data associated with a user. Based on the collected resource transfer data, the system may extract resource transfer patterns and subsequently generate a prediction of a resource transfer to occur in the future. In this regard, the system may use a scoring algorithm to calculate the degree of correlations between certain resource transfers. The system may then transmit one or more recommendations regarding the predicted resource transfer to the user. In this way, the system may provide an efficient way to execute resource transfers.

Accordingly, embodiments of the present disclosure provide a system for executing automatic resource transfers using predictive electronic data analysis. The system may comprise a memory device with computer-readable program code stored thereon; a communication device; and a processing device operatively coupled to the memory device and the communication device. The processing device may be configured to execute the computer-readable program code to continuously monitor resource transfer data associated with a user; detect, from the resource transfer data associated with the user, a recurring pattern of resource transfers; calculate a correlation score for a set of resource transfers within the recurring pattern of resource transfers; detect that the correlation score has increased above a system-defined threshold; and transmit a notification to the user comprising a recommendation to set up a recurring resource transfer based on the recurring pattern of resource transfers.

In some embodiments, calculating the correlation score for the set of resource transfers comprises determining one or more shared characteristics of the set of resource transfers; and based on the one or more shared characteristics, sequentially incrementing the correlation score for each resource transfer within the set of resource transfers.

In some embodiments, the one or more shared characteristics comprises at least one of transfer date, transfer amount, transfer label, and recipient information.

In some embodiments, sequentially incrementing the correlation score comprises detecting an exact match in the one or more shared characteristics of the set of resource transfers; and based on the exact match, incrementing the correlation score by a first value.

In some embodiments, sequentially incrementing the correlation score further comprises detecting a variance in the one or more shared characteristics of the set of resource transfers; and based on the variance, incrementing the correlation score by a second value, wherein the second value is lower than the first value.

In some embodiments, the notification further comprises an interactive link that, when activated, causes a form to be displayed on a computing device of the user, the form comprising one or more entry fields corresponding to one or more characteristics of the recurring resource transfer.

In some embodiments, at least a portion of the one or more entry fields are pre-populated based on the resource transfer data associated with the user.

Embodiments of the present disclosure also provide a computer program product for executing automatic resource transfers using predictive electronic data analysis. The computer program product may comprise at least one non-transitory computer readable medium having computer-readable program code portions embodied therein, the computer-readable program code portions comprising executable code portions for continuously monitoring resource transfer data associated with a user; detecting, from the resource transfer data associated with the user, a recurring pattern of resource transfers; calculating a correlation score for a set of resource transfers within the recurring pattern of resource transfers; detecting that the correlation score has increased above a system-defined threshold; and transmitting a notification to the user comprising a recommendation to set up a recurring resource transfer based on the recurring pattern of resource transfers.

In some embodiments, calculating the correlation score for the set of resource transfers comprises determining one or more shared characteristics of the set of resource transfers; and based on the one or more shared characteristics, sequentially incrementing the correlation score for each resource transfer within the set of resource transfers.

In some embodiments, the one or more shared characteristics comprises at least one of transfer date, transfer amount, transfer label, and recipient information.

In some embodiments, sequentially incrementing the correlation score comprises detecting an exact match in the one or more shared characteristics of the set of resource transfers; and based on the exact match, incrementing the correlation score by a first value.

In some embodiments, sequentially incrementing the correlation score further comprises detecting a variance in the one or more shared characteristics of the set of resource transfers; and based on the variance, incrementing the correlation score by a second value, wherein the second value is lower than the first value.

In some embodiments, the notification further comprises an interactive link that, when activated, causes a form to be displayed on a computing device of the user, the form comprising one or more entry fields corresponding to one or more characteristics of the recurring resource transfer.

Embodiments of the present disclosure also provide a computer-implemented method for executing automatic resource transfers using predictive electronic data analysis. The method may comprise continuously monitoring resource transfer data associated with a user; detecting, from the resource transfer data associated with the user, a recurring pattern of resource transfers; calculating a correlation score for a set of resource transfers within the recurring pattern of resource transfers; detecting that the correlation score has increased above a system-defined threshold; and transmitting a notification to the user comprising a recommendation to set up a recurring resource transfer based on the recurring pattern of resource transfers.

In some embodiments, calculating the correlation score for the set of resource transfers comprises determining one or more shared characteristics of the set of resource transfers; and based on the one or more shared characteristics, sequentially incrementing the correlation score for each resource transfer within the set of resource transfers.

In some embodiments, the one or more shared characteristics comprises at least one of transfer date, transfer amount, transfer label, and recipient information.

In some embodiments, sequentially incrementing the correlation score comprises detecting an exact match in the one or more shared characteristics of the set of resource transfers; and based on the exact match, incrementing the correlation score by a first value.

In some embodiments, sequentially incrementing the correlation score further comprises detecting a variance in the one or more shared characteristics of the set of resource transfers; and based on the variance, incrementing the correlation score by a second value, wherein the second value is lower than the first value.

In some embodiments, the notification further comprises an interactive link that, when activated, causes a form to be displayed on a computing device of the user, the form comprising one or more entry fields corresponding to one or more characteristics of the recurring resource transfer.

In some embodiments, at least a portion of the one or more entry fields are pre-populated based on the resource transfer data associated with the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the predictive resource transfer system, in accordance with one embodiment of the present disclosure; and

FIG. 2 illustrates a process flow for the predictive resource transfer system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity, or a third party who is not related to the entity.

Accordingly, the term “user device” or “mobile device” may refer to mobile phones, personal computing devices, tablet computers, wearable devices, and/or any stationary or portable electronic device capable of receiving and/or storing data therein.

“Resource” as used herein may refer to an object under the ownership of a user which is stored or maintained by the entity on the user's behalf. The resource may be intangible or tangible objects such as data files, documents, funds, and the like. Typically, an account associated with the user contains records of the resources owned by the user. Accordingly, account data may be stored in an account database within the entity's systems.

The system as described herein may automate resource transfer processes on behalf of a user as well as generate recommendations for recurring resource transfers. In this regard, the system may continuously collect resource transfer data (e.g., resource amount, transfer destination, metadata, and the like) associated with a user over time. Based on the collected resource transfer data, the system may detect one or more recurring resource transfer patterns. For example, a user may execute a certain type of resource transfer on at a regular period/interval over a certain period of time or at a certain frequency. Based on detecting the pattern, the system may generate one or more recommendations regarding future resource transfers to the user. The recommendations may include, for instance, a request to set up automatic recurring resource transfers based on historical resource transfer data. Upon detecting that the user has accepted the one or more recommendations, the system may implement the recommended resource transfer settings such that subsequent resource transfers are automatically executed as defined in the settings.

In an exemplary embodiment, a user holding an account with an entity (e.g., a financial institution) may conduct multiple resource transfers (e.g., a transaction) with shared characteristics. For example, the shared characteristics may include a payment amount (e.g., an exact number or within a defined margin of the exact number), transaction date, transaction schedule, payment platform or rail, transaction label, recipient information, and the like. Each repeated transaction (e.g., a transaction subsequent to another transaction with multiple shared characteristics) may increase a correlation score associated with transactions with the shared characteristics. The correlation score may represent the degree of confidence that a set of resource transfers are related. As the correlation score increases for a set of resource transfers, the system becomes increasingly confident that the resource transfers are recurring and will continue to be executed in the future. Accordingly, once the correlation score reaches a defined threshold, the system may detect a pattern of recurring transactions based on the shared characteristics. Based on the pattern, the system may transmit a notification to the user which contains a request to set up recurring transactions according to the detected pattern of shared characteristics.

The degree to which the correlation score changes may depend on the level of correlation of the shared characteristics. For instance, a recurring transaction which has 100% exact shared characteristics with the original transaction may increase the correlation score by a relatively higher amount. Conversely, a recurring transaction which has only some shared characteristics or has characteristics which have a degree of change or variance compared to those in the original transaction (e.g., slightly different payment amounts, changes in payment platform, slight changes in spelling in the transaction label, or the like) may cause the correlation score to increase by a relatively lower amount. In some embodiments, the correlation score between sets of transactions may decrease based on a lack of shared characteristics. Additionally, the system may be configured to increase the correlation score based on recognizing certain characteristics of the transaction. For instance, transaction labels containing certain words related to periodic payments (e.g., “dues,” “bill,” “monthly,” or the like) may increase the correlation score by relatively higher amounts compared to resource transfers without such transaction labels. Furthermore, the system may assign higher weights to certain characteristics than others. For instance, the system may give greater weight to transaction dates, payment amounts, and recipients than to payment rails or transaction labels. In this way, the system may be able to account for some inconsistencies in a set of recurring transactions. If the correlation score for a set of transactions is above 0 but below the defined threshold, the potentially related resource transfers may be added to a candidate table for continued monitoring.

Once the correlation score increases above the defined threshold, the system may add an entry to an offer table based on the related resource transfers. The entries in the offer table may then be used to provide recommendations to the user to set up recurring future resource transfers.

The following exemplary use cases are provided for illustrative purposes only and are not intended to limit the scope of the disclosure. In one embodiment, a first user may execute an initial transaction for a payment for $100 to a second user with a transaction label of “Book club” on January 1. If such a transaction is the first of its type, the correlation score may be set to 0. The first user may then, subsequent to the initial transaction, execute a second transaction for a payment for $100 to the second user with a transaction label of “Book club” on February 1. Based on comparing the characteristics of the second transaction in relation to the initial transaction, the system may determine one or more shared characteristics between the two transactions (e.g., payment dates exactly one month apart, same payment amount, same transaction parties, same transaction label). Accordingly, the system may increase the correlation score between the two transactions by an amount determined by the shared characteristics (e.g., increase to 40). Subsequently, the first user may execute a third transaction for a payment for $101 to the second user with a transaction label of “bookclub” on March 1. The system may then compare the characteristics of the third transaction with those of the first and second transaction. Although the third transaction has certain characteristics which are slightly different from those of the first and second transactions (e.g., a slightly higher payment amount and different spelling for the transaction label), the system may, based on the shared characteristics (e.g., payment date consistent with a monthly recurring payment, similarity of the payment amount and label, same recipient, and the like), once again increase the confidence score (e.g., increase to 80). If the confidence score increases above a defined threshold (e.g., 70), the system may determine that the three transactions are part of a pattern of recurring payments (e.g., monthly book club dues sent from the first user to the second user). The system may then transmit a notification to the user with a recommendation to set up recurring transactions based on the pattern detected from the user's historical data (e.g., the past three transactions).

Continuing the above example, the system may recommend that the user set up recurring payments on the first of every month for an amount of $100 to the second user. The notification may contain an interactive link which, when activated, displays a form on the user's computing device. The form may contain various entry fields for characteristics of the recurring transaction (e.g., transaction dates/frequency, payment amounts, transaction labels, payment platforms/rails, payment initiation period, recipient, and the like). One or more of the entry fields may be pre-populated based on the previous transactions in the pattern of recurring payments. Once the form has been populated, the user may submit the form to set up recurring payments that will automatically be executed based on the characteristics defined by the system and/or the user.

In some embodiments, the system may, instead of transmitting the notification immediately upon detecting an entry in the offer table, alter the time of transmission based on user defined-settings, user schedule data, and/or payment platform information. For instance, the system may prevent the notification from being sent during certain hours or on certain days, or select a notification date/time based on a payment due date and payment platform (e.g., if a certain payment platform requires 10 days to clear, the system may send a notification at least 11 days before the payment due date).

The system as described herein confers a number of technological advantages over conventional resource transfer systems. For instance, by automating certain recurring resource transfers, the system may prevent the need for the user to manually log onto the entity's networks to executing the resource transfers, thereby reducing the computing load and resources needed to fulfill the request (e.g., processing power, networking bandwidth, memory space, I/O calls, and the like).

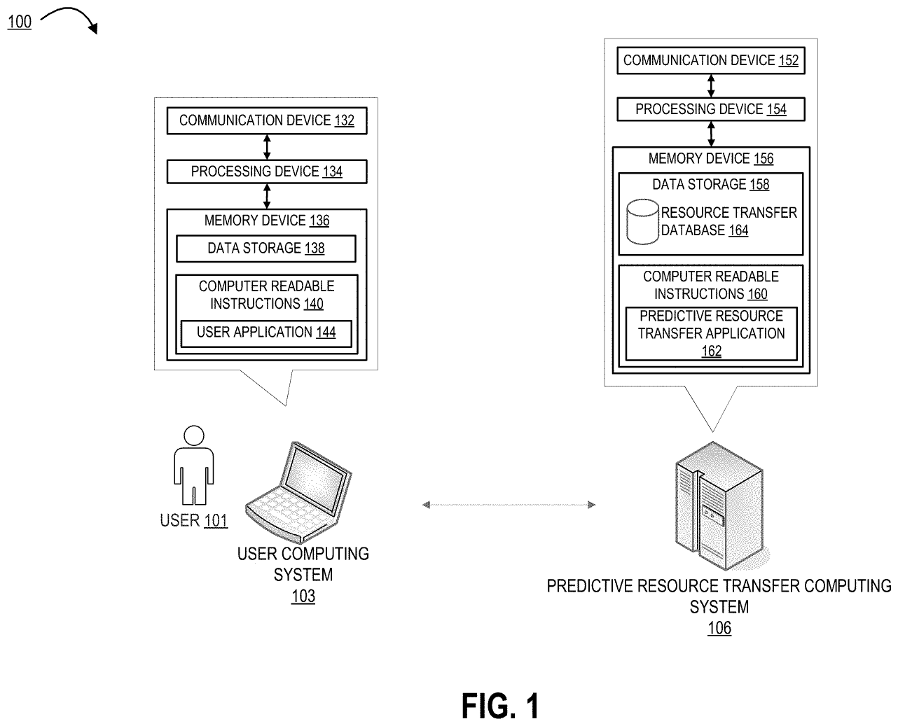

Turning now to the figures, FIG. 1 illustrates an operating environment 100 for the predictive resource transfer system, in accordance with one embodiment of the present disclosure. In particular, FIG. 1 illustrates a predictive resource transfer computing system 106 that is operatively coupled, via a network, to a user computing system 103. In such a configuration, the predictive resource transfer computing system 106 may, in some embodiments, transmit information to and/or receive information from the user computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. Furthermore, a single system, device, or server as depicted in FIG. 1 may represent multiple systems, devices, or servers. For instance, though the user computing system 103 is depicted as a single unit, the operating environment 100 may comprise multiple different user computing systems 103 operated by multiple different users.

The network may be a system specific distributive network receiving and distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

As illustrated in FIG. 1, the predictive resource transfer computing system 106 may be a computing system that performs the resource transfer analysis functions as described herein. Accordingly, the predictive resource transfer computing system 106 may comprise a communication device 152, a processing device 154, and a memory device 156. The predictive resource transfer computing system 106 may be a device such as a networked server, desktop computer, terminal, or any other type of computing system as described herein. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 154 is operatively coupled to the communication device 152 and the memory device 156. The processing device 154 uses the communication device 152 to communicate with the network and other devices on the network, such as, but not limited to the user computing system 103. The communication device 152 generally comprises a modem, antennae, WiFi or Ethernet adapter, radio transceiver, or other device for communicating with other devices on the network.

The memory device 156 may have computer-readable instructions 160 stored thereon, which in one embodiment includes the computer-readable instructions 160 of a predictive resource transfer application 162 which executes the recurring resource transfer prediction and correlation analysis functions as described herein. In some embodiments, the memory device 156 includes data storage 158 for storing data related to the system environment. In this regard, the data storage 158 may comprise a resource transfer database 164, which may include various types of data, metadata, executable code, or other types of information regarding the user, account information, historical resource transfer data, correlation scores, and the like.

As further illustrated in FIG. 1, the operating environment 100 may further comprise a user computing system 103 in operative communication with the predictive resource transfer computing system 106. The user computing system 103 may be a computing system that is operated by a user 101, such as a customer of the entity. Accordingly, the user computing system 103 may be a device such as a desktop computer, laptop, IoT device, smartphone, tablet, single-board computer, or the like. The user computing system 103 may further comprise a user interface comprising one or more input devices (e.g., a keyboard, keypad, microphone, mouse, tracking device, biometric readers, capacitive sensors, or the like) and/or output devices (e.g., a display such as a monitor, projector, headset, touchscreen, and/or auditory output devices such as speakers, headphones, or the like).

The user computing system 103 may further comprise a processing device 134 operatively coupled to a communication device 132 and a memory device 136 having data storage 138 and computer readable instructions 140 stored thereon. The computer readable instructions 140 may comprise a user application 144 which may receive inputs from the user 101 and produce outputs to the user 101. In particular, the user application 144 may comprise various applications which allow the user 101 to interact with the predictive resource transfer computing system 106 (e.g., executing resource transfers, receiving notifications and/or recommendations, scheduling recurring resource transfers, or the like).

The communication devices as described herein may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the computing systems may also include a communication interface device that may be connected by a hardwire connection to the resource distribution device. The interface device may comprise a connector such as a USB, SATA, PATA, SAS or other data connector for transmitting data to and from the respective computing system.

The computing systems described herein may each further include a processing device communicably coupled to devices as a memory device, output devices, input devices, a network interface, a power source, a clock or other timer, a camera, a positioning system device, a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user, may include any of a number of devices allowing the devices to receive data from a user, such as a keypad, keyboard, touch-screen, touchpad, microphone, mouse, joystick, other pointer device, button, soft key, and/or other input device(s).

The devices may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

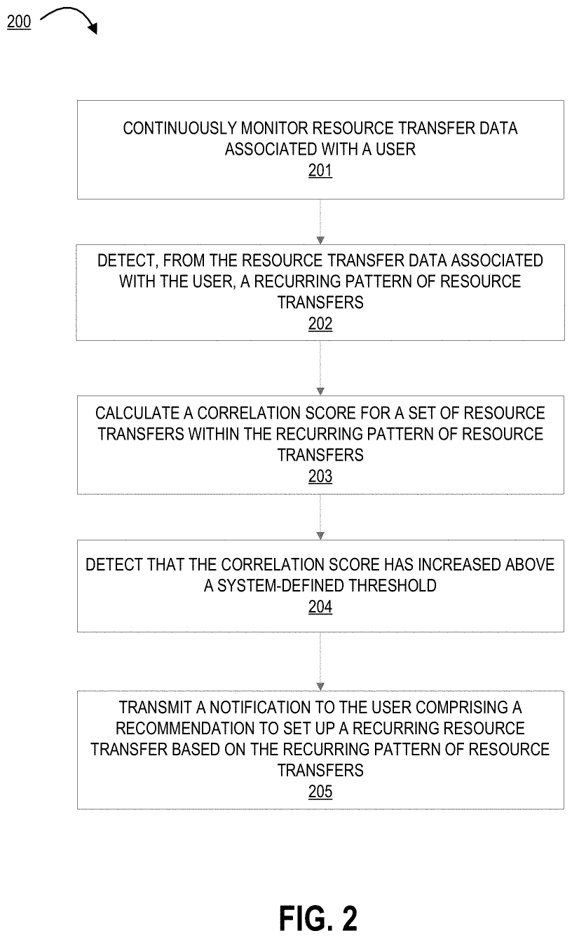

FIG. 2 illustrates a process flow 200 for the predictive resource transfer system, in accordance with some embodiments of the present disclosure. The process begins at block 201, where the system continuously monitors resource transfer data associated with the user. In particular, the system may record each resource transfer associated with a user within a historical database. In an exemplary embodiment, a user may use an account associated with an entity to conduct various transactions over time. The system may store records of each transaction executed by the user along with transaction metadata (e.g., account information, transaction date and/or schedule, transaction amount, transaction label, payment platform, recipient information, and the like).

In an exemplary embodiment, a first user may execute a series of resource transfers to a second user having certain characteristics. In particular, a first transaction may be a transfer of $800 to the second user via immediate wire transfer with a transaction label of “Childcare” on January 1. A second transaction may be a transfer of $801 to the second user via immediate wire transfer with a transaction label of “jan” on January 15. A third transaction may be a transfer of $850 to the second user via scheduled ACH with a transaction label of “Child care” on February 1. Finally, a fourth transaction may be a transfer of $801 to the second user via immediate wire transfer with a transaction label of “Child care” on February 15. The system may record all four resource transfers within the database of historical resource transfers associated with the user. Subsequently, the system may perform one or more processes to analyze the historical data, as described further herein.

The process continues to block 202, where the system detects, from the resource transfer data associated with the user, a recurring pattern of resource transfers. The system may determine that one or more resource transfers within the historical data have shared characteristics from which to detect a recurring pattern. For instance, continuing the above example, the system may detect that the four transactions associated with the user are related based on characteristics such as the regularity at which the transaction are executed (e.g., on the 1^{st} and 15^{th} of the month), the similarity of payment amount (e.g., ranges from $800 to $850), the identity of the recipient (e.g., the second user), the similarity of resource transfer labels (e.g., involving childcare), and the like. Once the system detects a pattern for one or more resource transfers, the system may add entries for said resource transfers within a candidate database. Associated resource transfers within the candidate database may be monitored further to confirm the existence of a pattern.

The process continues to block 203, where the system calculates a correlation score for a set of resource transfers within the recurring pattern of resource transfers. The correlation score may indicate the probability that the resource transfers with which the correlation score is associated are part of a recurring set of resource transfers. Accordingly, the correlation score may be sequentially incremented with every resource transfer within the same pattern. Exact matches in the shared characteristics of the resource transfers may increase the correlation score by a relatively higher degree (e.g., a first value), whereas variances or changes in the shared characteristics may increase the correlation score by a relatively lower degree (e.g., a second value lower than the first value). For instance, continuing the above example, the correlation score associated with the first transaction may start at 0. Once the second transaction has been recorded, the system may increase the correlation score associated with the first transaction by a certain amount depending on the characteristics shared between the first transaction and second transaction. Certain shared characteristics may have a greater impact on the increase in correlation score than other characteristics. For example, although the transaction label for the first and second transactions are different, the time frequency of the transactions (e.g., two weeks apart), the similarity in transfer amounts (e.g., $800 vs. $801), and commonality of recipient (e.g., the second user) may cause the correlation score to increase (e.g., from 0 to 40). At this stage, the system may determine that the two transactions may be related.

As described above, the system may continue adjusting the correlation score for each subsequent transaction. For instance, based on the differences in the transaction amount ($850 vs. $800 vs. $801) and difference in payment platform (e.g., ACH vs. wire transfer) but similarity in transaction labels of the first and third transactions (e.g., “Childcare” vs. “Child care”) and transaction frequency (e.g., three transactions are two weeks apart), the system may increase the correlation score associated with the three transactions by a relatively smaller amount (e.g., from 40 to 55), indicating that the system has become more confident that the three transactions are related. Furthermore, based on the similarities of the transaction frequency, payment amounts, transaction labels, and payment platforms of the fourth transaction compared to the first three transactions, the system may further increase the correlation score associated with the four transactions (e.g., from 55 to 95). In some embodiments, the system may be further configured to detect certain keywords from the transaction label. For instance, certain words such as “dues,” “bill,” “monthly,” or the like may be indicative of a recurring payment and thus cause the correlation score to increase by a relatively higher amount.

The process continues to block 204, where the system detects that the correlation score has increased above a system-defined threshold. The threshold may be defined by the system to strike a balance between preventing false positives and timely assessment of recurring resource transfer patterns. Continuing the above example, the threshold may be set to 80. Upon detecting that the correlation has increased to 95 (e.g., above the threshold of 80), the system may determine/confirm that the four transactions are related as a pattern of recurring payments. Accordingly, the system may move the associated entries from the candidate table to the offer table, where entries in the offer table may be presented to the user as recommendations.

The process concludes at block 205, where the system transmits a notification to the user comprising a recommendation to set up a recurring resource transfer based on the recurring pattern of resource transfers. Said recommendation may be transmitted through one or more of various communication channels (e.g., in-app, e-mail, text message, or the like). The recommendation may include a query (e.g., “Would you like to set up a recurring transfer?”) along an interactive link (e.g., a button labeled “Yes”) which may be activated by the user to initiate the set up process for the recurring resource transfer. The system may then display a recurring resource transfer set up form to the user, where the form may contain various fields that may be edited by the user. The fields may correspond to the various characteristics of the recurring resource transfer, as described elsewhere herein. In some embodiments, one or more fields may be pre-populated based on the characteristics of past associated resource transfers (e.g., the most frequently appearing characteristic). For instance, continuing the above example, the system may pre-populate the frequency (e.g., next transfer scheduled for March 1), the amount (e.g., $801), payment platform (e.g., wire transfer), transaction label (e.g., “child care”), recipient (e.g., the second user), and the like. Alternatively or in addition, the recommendation may provide another query (e.g., “Would you like to initiate a transfer now?”) with another interactive link which may be activated by the user to initiate an immediate transfer based on the characteristics of the related transfers. In some embodiments, the system may be configured to recommend a payment platform depending on its cost efficiency and/or clearing time. In this way, the system provides an efficient way for users to execute recurring resource transfers.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for executing automatic resource transfers using predictive electronic data analysis, the system comprising:
a memory device with computer-readable program code stored thereon;
a communication device; and
a processing device operatively coupled to the memory device and the communication device, wherein the processing device is configured to execute the computer-readable program code to:
continuously monitor resource transfer data associated with a user;
detect, from the resource transfer data associated with the user, a recurring pattern of resource transfers;
calculate a correlation score for a set of resource transfers within the recurring pattern of resource transfers;
detect that the correlation score has increased above a system-defined threshold; and
transmit a notification to the user comprising a recommendation to set up a recurring resource transfer based on the recurring pattern of resource transfers.

2. The system according to claim 1, wherein calculating the correlation score for the set of resource transfers comprises:
determining one or more shared characteristics of the set of resource transfers; and
based on the one or more shared characteristics, sequentially incrementing the correlation score for each resource transfer within the set of resource transfers.

3. The system according to claim 2, wherein the one or more shared characteristics comprises at least one of transfer date, transfer amount, transfer label, and recipient information.

4. The system according to claim 2, wherein sequentially incrementing the correlation score comprises:
detecting an exact match in the one or more shared characteristics of the set of resource transfers; and
based on the exact match, incrementing the correlation score by a first value.

5. The system according to claim 4, wherein sequentially incrementing the correlation score further comprises:
detecting a variance in the one or more shared characteristics of the set of resource transfers; and
based on the variance, incrementing the correlation score by a second value, wherein the second value is lower than the first value.

6. The system according to claim 1, wherein the notification further comprises an interactive link that, when activated, causes a form to be displayed on a computing device of the user, the form comprising one or more entry fields corresponding to one or more characteristics of the recurring resource transfer.

7. The system according to claim 6, wherein at least a portion of the one or more entry fields are pre-populated based on the resource transfer data associated with the user.

8. A computer program product for executing automatic resource transfers using predictive electronic data analysis, the computer program product comprising at least one non-transitory computer readable medium having computer-readable program code portions embodied therein, the computer-readable program code portions comprising executable code portions for:
continuously monitoring resource transfer data associated with a user;
detecting, from the resource transfer data associated with the user, a recurring pattern of resource transfers;
calculating a correlation score for a set of resource transfers within the recurring pattern of resource transfers;
detecting that the correlation score has increased above a system-defined threshold; and
transmitting a notification to the user comprising a recommendation to set up a recurring resource transfer based on the recurring pattern of resource transfers.

9. The computer program product according to claim 8, wherein calculating the correlation score for the set of resource transfers comprises:
determining one or more shared characteristics of the set of resource transfers; and
based on the one or more shared characteristics, sequentially incrementing the correlation score for each resource transfer within the set of resource transfers.

10. The computer program product according to claim 9, wherein the one or more shared characteristics comprises at least one of transfer date, transfer amount, transfer label, and recipient information.

11. The computer program product according to claim 9, wherein sequentially incrementing the correlation score comprises:
detecting an exact match in the one or more shared characteristics of the set of resource transfers; and
based on the exact match, incrementing the correlation score by a first value.

12. The computer program product according to claim 11, wherein sequentially incrementing the correlation score further comprises:
detecting a variance in the one or more shared characteristics of the set of resource transfers; and
based on the variance, incrementing the correlation score by a second value, wherein the second value is lower than the first value.

13. The computer program product according to claim 8, wherein the notification further comprises an interactive link that, when activated, causes a form to be displayed on a computing device of the user, the form comprising one or more entry fields corresponding to one or more characteristics of the recurring resource transfer.

14. A computer-implemented method for executing automatic resource transfers using predictive electronic data analysis, wherein the method comprises:
continuously monitoring resource transfer data associated with a user;
detecting, from the resource transfer data associated with the user, a recurring pattern of resource transfers;
calculating a correlation score for a set of resource transfers within the recurring pattern of resource transfers;
detecting that the correlation score has increased above a system-defined threshold; and
transmitting a notification to the user comprising a recommendation to set up a recurring resource transfer based on the recurring pattern of resource transfers.

15. The computer-implemented method according to claim 14, wherein calculating the correlation score for the set of resource transfers comprises:
determining one or more shared characteristics of the set of resource transfers; and
based on the one or more shared characteristics, sequentially incrementing the correlation score for each resource transfer within the set of resource transfers.

16. The computer-implemented method according to claim 15, wherein the one or more shared characteristics comprises at least one of transfer date, transfer amount, transfer label, and recipient information.

17. The computer-implemented method according to claim 15, wherein sequentially incrementing the correlation score comprises:
detecting an exact match in the one or more shared characteristics of the set of resource transfers; and
based on the exact match, incrementing the correlation score by a first value.

18. The computer-implemented method according to claim 17, wherein sequentially incrementing the correlation score further comprises:
detecting a variance in the one or more shared characteristics of the set of resource transfers; and
based on the variance, incrementing the correlation score by a second value, wherein the second value is lower than the first value.

19. The computer-implemented method according to claim 14, wherein the notification further comprises an interactive link that, when activated, causes a form to be displayed on a computing device of the user, the form comprising one or more entry fields corresponding to one or more characteristics of the recurring resource transfer.

20. The computer-implemented method according to claim 19, wherein at least a portion of the one or more entry fields are pre-populated based on the resource transfer data associated with the user.
